(19) United States
(12) Patent Application Publication
(10) Pub. No.: US 2009/0294076 A1
(43) Pub. Date: Dec. 3, 2009

(54) BOTTOM RAIL ANCHOR FOR CORD LADDER

(75) Inventor: Claude McNiel, Chandler, AZ (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 12/469,338

(22) Filed: May 20, 2009

Related U.S. Application Data
(60) Provisional application No. 61/056,258, filed on May 27, 2008.

(51) Int. Cl. E06B 9/00

(52) U.S. Cl. 160/127

(57) ABSTRACT

A system for anchoring a cord ladder to a bottom rail of a covering for an architectural opening includes an anchor positioned in the bottom rail with a rotatable drum about which the vertical side cords of the cord ladder can be selectively wrapped to any desired degree for adjusting the effective length of the side cords and thus the tension in the side cords.

### CROSS REFERENCE TO RELATED APPLICATION

The present application claims the benefit under 35 U.S.C. §119(e) of U.S. provisional patent application No. 61/056,258 filed on May 27, 2008 and entitled “Bottom Rail Anchor For Cord Ladder”, and is incorporated by reference into the present application in its entirety.

### BACKGROUND OF THE INVENTION

1. Field of the Invention

The present invention relates generally to retractable coverings for architectural openings that utilize a cord ladder for supporting slats so the slats can be tilted about longitudinal axes between open and closed positions or raised and lowered between retracted and extended positions of the covering and particularly to a system for securing the cord ladder to a bottom rail of the covering.

2. Description of the Relevant Art

Retractable coverings for architectural openings such as windows, doors, archways, and the like, have taken numerous forms over a long period of time. One form of such a covering is referred to as a Venetian Blind and incorporates a plurality of horizontally disposed slats that are supported by cord or tape ladders at horizontally-spaced locations along the length of the slats. The cord ladders are designed to tilt the slats about their longitudinal axes between an open position wherein the slats are horizontally disposed defining a space therebetween through which vision and light can pass and a closed position wherein the slats are substantially vertically oriented in overlapping relationship to block the passage of vision and light therethrough.

Cord ladders include a pair of vertically-extending side cords and interconnecting horizontal rungs, which are vertically spaced and provide a support surface for the slats in a Venetian Blind type covering. The slats are tilted by shifting the vertical side cords in opposite vertical directions, which causes the interconnecting rungs to tilt and thereby tilt the slats in unison with the rungs. Lift cords are also provided in Venetian Blind type coverings, which extend from a headrail for the covering to a bottom rail so that wrapping the lift cords around spools in the headrail will shorten their effective lengths thereby raising the lower ends of the lift cords. Raising the lower ends of the lift cords raises the bottom rail thereby gathering the cord ladders and the supported slats to move the covering from an extended position across an architectural opening toward a retracted position wherein the slats are neatly stacked adjacent the top of the architectural opening in which the Venetian Blind is mounted.

The lift cords typically extend downwardly through the bottom rail and are knotted beneath the bottom rail so as to support the bottom rail and there are at least two lift cords utilized so that the bottom rail can be raised and lowered while maintaining a horizontal orientation. Other systems have been devised for securing the bottom end of a lift cord to the bottom rail such as shown for example in pending U.S. patent application Ser. No. 11/550,524, filed Oct. 18, 2006, which published as U.S. patent publication No. 2007/0089839 A1 on Apr. 26, 2007 and entitled “Lift Cord Anchor For Coverings For Architectural Openings”, which is of common ownership with the present application. In that application, the system for securing the lower end of a lift cord to the bottom rail is designed so that the length of the lift cord can be easily adjusted whereby the bottom rail can be positioned immediately adjacent or contiguous with a window sill, door jam, or the like, as desired. In other words, the connection is adjustable.

The cord ladders are also connected to the bottom rail so they move in unison with the bottom rail. The cord ladders therefore move between extended and retracted positions by lowering or raising the bottom rail with the lift cords. Cord ladders are connected to the bottom rail in numerous manners, but it will be appreciated it would be desirable if the cord ladders were adjustably connected to the bottom rail so that upon proper positioning of the bottom rail within an architectural opening with a desired connection between lift cords and the bottom rail, the cord ladders can be adjusted so as to also conform to the size of the architectural opening while desirably supporting the slats of the Venetian Blind in a uniformly spaced array above the bottom rail.

It is to provide an adjustable system for connecting a cord ladder to a bottom rail that the present invention has been developed.

### SUMMARY OF THE INVENTION

The present invention constitutes an adjustable system or anchor for interconnecting cord ladders with a bottom rail of a covering for an architectural opening. The connection system includes a housing fixedly positioned within a recess provided in the bottom surface of the bottom rail with the housing rotatably supporting a drum to which the bottom ends of the side cords of a cord ladder are operatively connected so the side cords can be selectively wrapped about or unwrapped from the drum.

The drum and the housing also have cooperating projections and detents for retaining the drum in any selected rotative position relative to the housing whereby the effective length of each side cord of the cord ladder will dependably remain in a selectively adjusted position. It will also be appreciated with the detailed description hereafter that not only can the side cords be desirably tensioned and their lengths selectively set through adjustment of the anchor, but the transverse inclination or tilt of the bottom rail can also be manipulated by holding the rail in a predetermined orientation when setting the anchor.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is a fragmentary isometric of a portion of a venetian blind type covering incorporating the cord ladder anchor of the present invention.

FIG. 2 is an enlarged fragmentary section taken along line 2-2 of FIG. 1.

FIG. 3 is a further enlarged section taken along line 3-3 of FIG. 2.

FIG. 3A is a fragmentary isometric showing the bottom of a cord ladder prior to incorporation into the anchor of the present invention.

FIG. 3B is a fragmentary isometric showing the bottom of a cord ladder incorporated into the drum component of the anchor of the invention.

FIG. 4 is an isometric similar to FIG. 3B with the drum having been positioned within the housing of the anchor of the invention.

FIG. 5 is a fragmentary vertical section taken through a bottom rail in which the anchor of the present invention has been incorporated.

FIG. 6 is a section taken along line 6-6 of FIG. 5.

FIG. 7 is an enlargement of the area circled in dashed lines in FIG. 6.

FIG. 8 is a vertical section similar to FIG. 5 with the drum having been rotated in the direction of the arrows relative to the housing of the anchor.

FIG. 9 is a fragmentary isometric with parts of the housing removed showing the drum component of the anchor positioned within the housing component.

FIG. 10 is an isometric looking downwardly on the housing component of the anchor of the invention.

FIG. 11 is an isometric looking downwardly on the bottom of the housing, which has been inverted relative to FIG. 10.

FIG. 12 is an isometric looking downwardly on the drum component of the anchor.

FIG. 13 is an isometric looking downwardly on the bottom of the drum component after it has been inverted relative to FIG. 12.

### DETAILED DESCRIPTION OF THE INVENTION

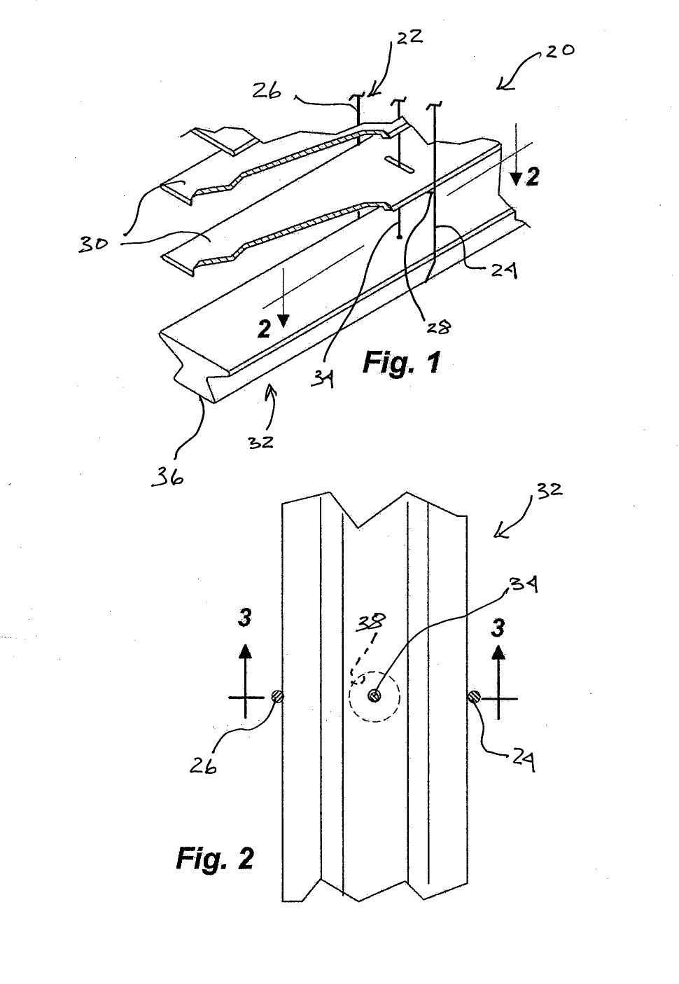

Referring first to FIG. 1, a portion of a Venetian Blind type covering 20 incorporating the anchor of the present invention is illustrated. The covering includes a plurality of conventional cord ladders 22, each having front 24 and rear 26 vertically-extending side cords and substantially horizontal interconnecting rungs 28. There is a plurality of such rungs spaced vertically along the length of each side cord and each rung supports a slat 30 forming part of a shade component of the covering. The slats are pivotal about longitudinal axes when the rung on which they are supported is tilted, which occurs when the front and rear side cords are simultaneously moved in opposite vertical directions. The covering further includes a bottom rail 32 to which the cord ladder is connected in accordance with the present invention and also to which lift cords 34 are connected for raising and lowering the bottom rail in a conventional manner. There are a plurality of cord ladders and lift cords in the covering so that the bottom rail and the slats supported by the cord ladders remain horizontally disposed within an architectural opening while being movable between an extended position and a retracted position. In the extended position, the bottom rail is disposed adjacent to the bottom of the architectural opening and the slats are vertically spaced above the bottom rail in a uniform array between the bottom rail and the headrail (not shown) for the covering. In the retracted position, the bottom rail and slats are raised and neatly stacked beneath and adjacent to the headrail.

When the cord ladder 22 is manipulated by moving the front 24 and rear 26 side cords as mentioned above in opposite vertical directions to cause the cross rungs 28 to tilt and thereby tilt the slats 30 supported thereon, the covering 20 can be moved between an open condition wherein the slats are substantially horizontally disposed as illustrated in FIG. 1 permitting the passage of vision and light therebetween, and a closed position (not illustrated) wherein the slats are substantially vertically oriented and overlap each other to prevent the passage of vision and light therebetween. By raising the lift cords 34 such as by wrapping the lift cords around spools or rollers (not shown) in the headrail, the bottom rail can be moved from the extended position shown in FIG. 1 to the retracted or elevated position.

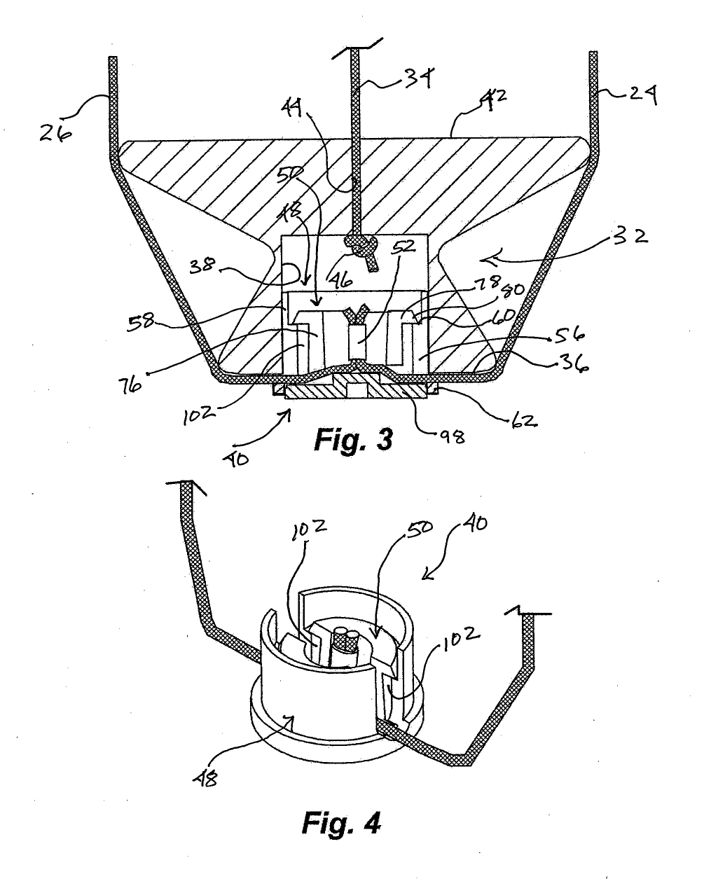

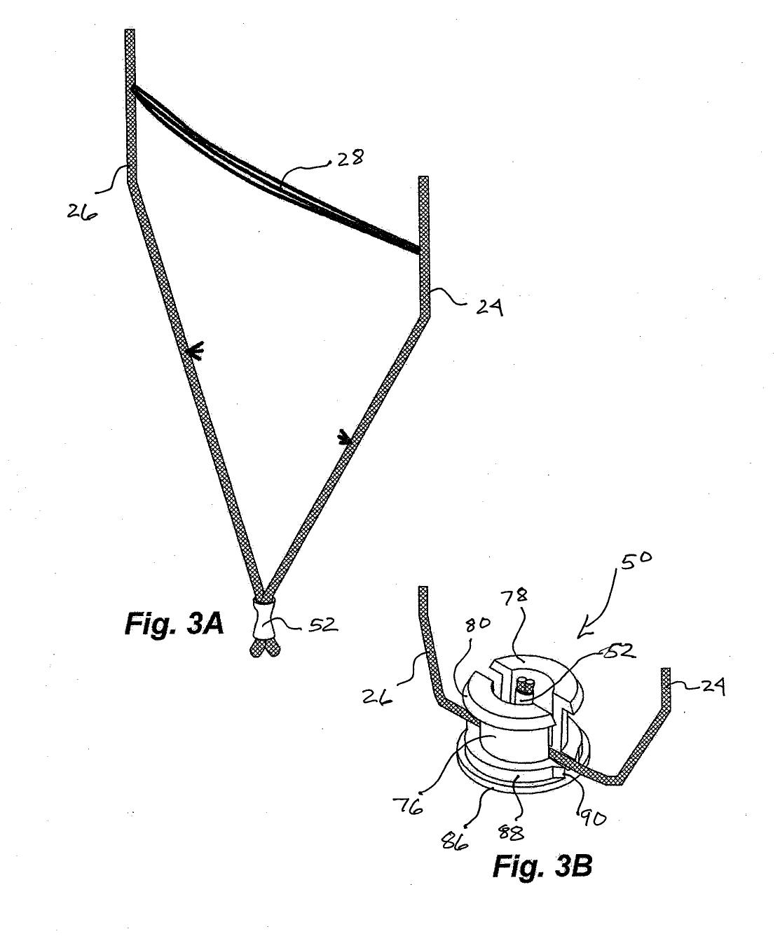

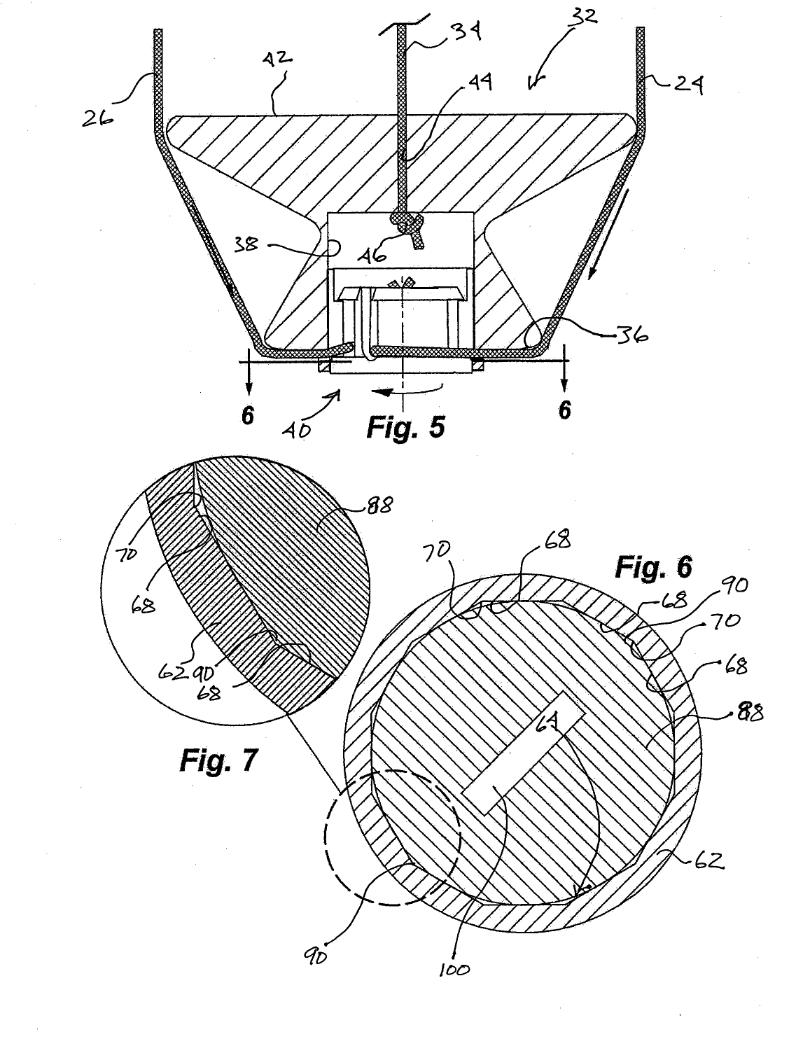

In accordance with the present invention, and as appreciated by reference to FIG. 3, the bottom 36 of the bottom rail 32 is provided with a plurality of longitudinally spaced cylindrical recesses 38 associated with each cord ladder 22 and with at least some of the lift cords 34. Each cylindrical recess is adapted to receive an anchor 40, as will be described in more detail hereafter, and communicates with the top 42 of the bottom rail in some instances with a vertical passage 44 through which a lift cord can be extended. The bottom end 46 of the lift cord is knotted within the recess 38 so that the lift cord can be elevated and lowered to raise and lower the bottom rail in moving the covering between the retracted and extended positions. Of course, the system for connecting the lift cord to the bottom rail, which is illustrated in FIG. 3 as simply a knot tied in the bottom of the lift cord, could be a more sophisticated system as described in the aforenoted pending application U.S. patent application Ser. No. 11/550,524, which published as U.S. patent publication No. 2007/0089839 A1, the disclosure of which is hereby incorporated by reference. The number of lift cords and cord ladders utilized in any covering depends upon the length of the covering and there may be more cord ladders, for example, than lift cords or vice versa. If a lift cord were not provided at the location of a cord ladder, the passage 44 for the lift cord would not be necessary.

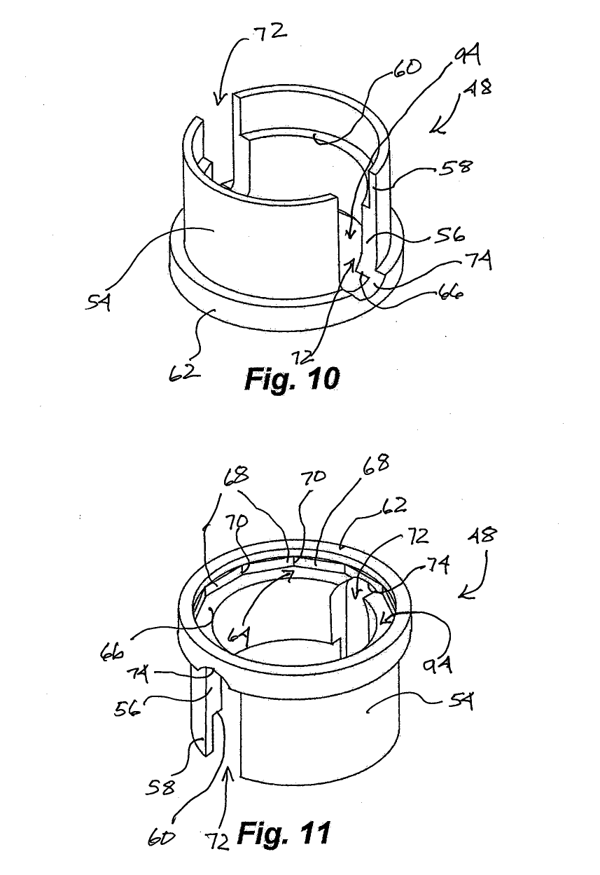

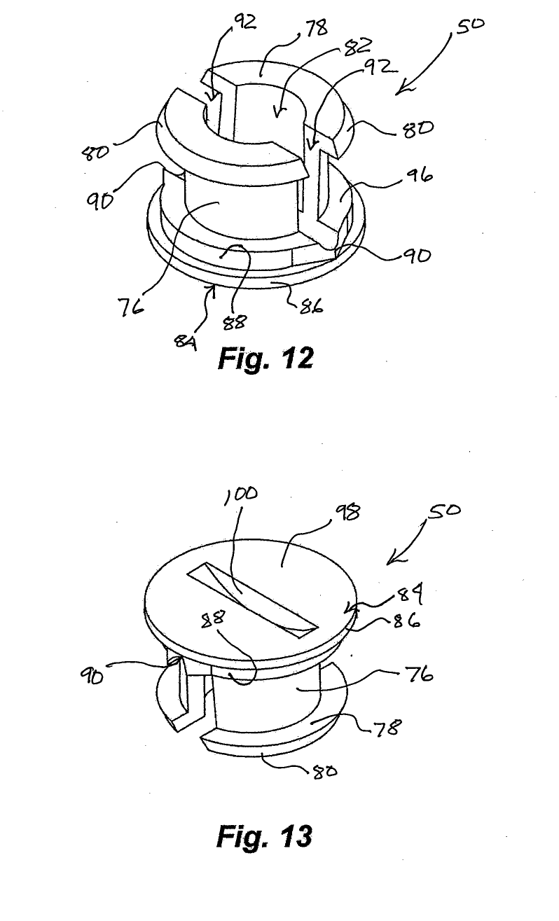

With reference to FIGS. 4 and 9, the cord anchor 40 can be seen to include two component parts: an outer housing 48 and an inner drum 50, the drum being reversibly rotatable within the outer housing. The outer housing is seen separated from the drum in FIGS. 10 and 11 with the drum being shown separated from the housing in FIGS. 12 and 13. Before describing the details of each component of the anchor, however, it will be appreciated by reference to FIGS. 4 and 9 that the lower ends of the front 24 and rear 26 vertical side cords of a cord ladder 22 are interconnected such as by crimping with a soft metallic sleeve 52 and are positioned within the drum component. Rotation of the drum component 50 relative to the housing 48, as shown in FIG. 9, can be seen to cause the lower portion of each front and rear side cord to wrap around the drum, which in effect shortens the effective length of each side cord with the effective length being the exposed length of a side cord from the headrail to the anchor.

Looking at FIGS. 10 and 11, the housing component 48 of the anchor 40 is shown in FIG. 10 in a normal orientation as it would sit within a recess 38 in the bottom 36 of the bottom rail 32, while in FIG.11 the housing component is shown inverted. The housing component can be seen to include a cylindrical wall or main body 54 having a lower relatively thick section 56 and an upper relatively thin section 58 defining a horizontal arcuate shoulder 60 along the inner wall of the cylindrical body between the upper and lower sections. The cylindrical body sits on a slightly larger diameter integral ring 62 and defines an inwardly facing surface beneath the cylindrical main body which is serrated to define an annular detent surface 64 as best seen in FIG. 11. The detent surface is positioned immediately beneath an overhang or horizontal ring 66 within the housing and is comprised of a plurality of chordal walls 68 which form an obtuse angle with the next adjacent chordal wall so that at the intersection of each chordal wall a V-shaped detent 70 is defined for a purpose to be described hereafter. It can also be seen by reference to FIGS. 10 and 11 that diametrically opposed slots 72 are provided through the cylindrical main body with the slots extending into the top surface of the ring 62 to establish a radiating pair of channels 74 in the top surface of the ring for a purpose to be described hereafter.

With reference to FIGS. 12 and 13, the drum component 50 of the anchor 40 can also be seen to include a cylindrical main body 76 having an integral upper top ring 78 with an inwardly and upwardly beveled outer edge 80. The cylindrical body and upper ring define a substantially cylindrical chamber 82 within the drum. The cylindrical body sits on an integral disk-like bottom plate 84 having a lower relatively large diameter portion 86 and an upper smaller diameter portion 88. The upper smaller diameter portion has diametrically opposed projections or peaks 90 (even though there could be any desired number) directed radially outwardly in opposite directions which conform in cross-sectional configuration to the detents 70 formed by adjacent chordal walls 68 of the housing component 48. The rotatable drum also has diametrically opposed slots 92 formed through the cylindrical body 76, the upper ring 78 and a portion of the top of the lower disk 84 for a purpose to be described hereafter.

The drum component 50 of the anchor 40 is rotatably seatable in the housing component 48 as is probably best illustrated in FIGS. 3, 4, 8 and 9. It will there be seen the rotatable drum component can be inserted upwardly through a circular opening 94 in the bottom of the housing component until the top ring 78 of the drum rests on the shoulder 60 within the interior of the housing component. It should be noted the drum and the housing are both integral bodies made of a rigid but somewhat resilient material such as nylon, plastic, or the like, so that the beveled edge 80 of the top ring will cause the opposing halves of the drum on either side of the opposed slots 92 to flex inwardly until the top ring 78 overlies the shoulder 60 within the housing and due to the resiliency of the material from which the drum is made, it will flex outwardly so the top ring is rotatably supported on the shoulder within the housing and thereby mechanically maintained in the housing.

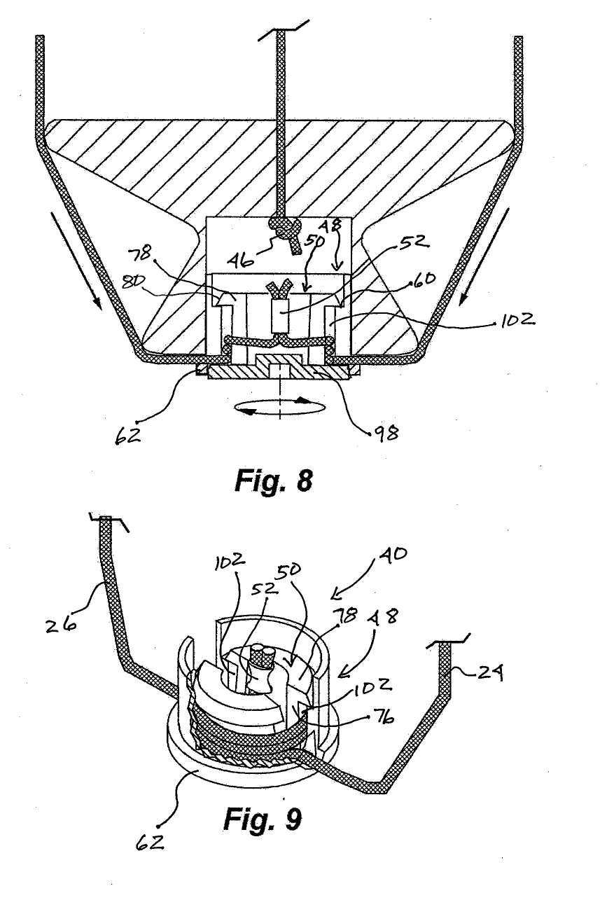

A top ledge 96 of the upper portion 88 of the bottom plate 84 on the drum 50 engages the overhang 66 in the housing 48 when the top ring 78 of the drum is seated on the shoulder 60 of the housing, which prevents relative axial movement between the drum and the housing when they are assembled. It will also be appreciated that due to the cylindrical nature of the interior of the housing, the bottom plate 84 and top ring 78 of the drum that the drum can reversibly rotate within the housing. However, as is possibly best appreciated by reference to FIGS. 3 and 8, the diametrically opposed projections 90 on the drum are at a common elevation with the detent surface 64 in the housing and due to the resilient nature of the materials from which the housing and the drum are made, rotation of the drum relative to the housing will cause the projections to shift or snap between detents 70 within the housing which releasably retains the drum in any desired rotative position relative to the housing.

The bottom surface 98 of the drum 50 has a linear recess 100 adapted to receive a screwdriver head, for example, so that a screwdriver or other suitable instrument could be used to rotate the drum relative to the housing 48 and move the projections 90 on the drum between detents 70 in the housing so that the drum is selectably movable between releasably fixed positions for a purpose to be described hereafter.

The outer diameter of the cylindrical main body 54 of the housing 48 is slightly larger than the inner diameter of the recess 38 in the bottom rail 32 in which the anchor 40 is positioned so that the housing can be forced into the recess and press-fit therein. Once inserted, it does not change position even though as mentioned previously, the drum 50 can be rotated within the interior of the housing and the housing could be removed from a recess, if desired.

As also mentioned previously, the lower ends of the front 24 and rear 26 side cords are crimped together and as can be appreciated by reference to FIG. 4, these ends are inserted through the opposed slots 72 in the housing 48 and the opposed slots 92 in the drum 50 when they are aligned with each other so that the ends of the side cords are directed upwardly and positioned within the hollow interior of the drum. The side cords pass through the channels 74 formed in the lower ring 62 of the housing so that even when the housing is inserted in a recess in the bottom rail, the side cords can slide within the channels of the housing beneath the bottom surface 36 of the bottom rail 32. It should also be appreciated by reference to FIGS. 4 and 9 that there is an annular cylindrical space 102 between the generally cylindrical main bodies of the drum and the housing. Accordingly, when the drum is rotated relative to the housing as with a screwdriver applied to the recess 100 in the base of the drum, the cords are confined to entering the housing through the diametrically opposed slots 72 formed therein and will wrap around the main body 76 of the drum within the cylindrical space defined between the drum and the housing. By wrapping the front and rear side cords around the drum, the effective length of each cord is shortened, i.e. the length of a side cord between the anchor 40 and the headrail (not shown) for the covering. Through an adjustment of the drum relative to the housing in one direction or the other, the side cords can be made taut when the bottom rail is in its fully-extended position, thus rendering the slats 30 desirably spaced above the bottom rail and beneath the headrail.

It will also be appreciated that if it were desired to laterally tilt the bottom rail 32 (not shown) while leaving it longitudinally horizontally oriented, as shown in FIGS. 3 and 8, one could hold the rail in a desirably laterally tilted orientation while adjusting the number of wraps of side cords around the drum 50 and one side cord would wrap more tightly than the other allowing the lateral orientation of the bottom rail to assume and maintain any desired angle relative to horizontal.

Pursuant to the above, it will be seen that a system has been described which permits a positive interconnection between a bottom rail of a covering for an architectural opening and a cord ladder so that the cord ladder is positively positioned relative to the bottom rail and the tension in the vertical side cords are adjusted to a desired tightness to make sure the slats are desirably and uniformly spaced between the bottom rail and the headrail for the covering. The lateral orientation of the bottom rail can also be adjusted in the same manner by holding the bottom rail in a desired lateral tilted orientation when adjusting the tension in the front and rear side cords.

Although the present invention has been described with a certain degree of particularity, it is understood the disclosure has been made by way of example, and changes in detail or structure may be made without departing from the spirit of the invention as defined in the appended claims.

What is claimed is:

1. The combination of a shade material having a bottom rail, a cord ladder for supporting the shade material, and an anchor for connecting the cord ladder to the bottom rail comprising:
a shade material adapted to be extended and retracted and having a rigid bottom rail,
a cord ladder for supporting the shade material, said cord ladder including a pair of elongated vertical side cords interconnected at vertically spaced locations by horizontal rungs, said side cords having bottom ends, and
an anchor including a rotatable drum about which said bottom ends of said side cords can be selectively wrapped, said anchor being fixed in said bottom rail such that said drum remains rotatable whereby the effective length of said side cords can be selectively adjusted by wrapping selected lengths of said side cords about said drum.

2. The combination of claim 1 wherein said bottom rail includes a bottom wall with a recess therein and wherein said anchor further includes a housing fixedly positioned in said recess and rotatably supporting said drum.

3. The combination of claim 2 wherein said drum includes a circumferential wall about which said side cords can be wrapped.

4. The combination of claim 3 wherein said circumferential wall surrounds an internal chamber and has at least one slot therethrough to permit access to said internal chamber through said circumferential wall.

5. The combination of claim 4 wherein said housing has an outer wall with at least one slot therethrough and wherein through selective rotation, said at least one slot in said housing is alignable with said at least one slot in said drum.

6. The combination of claim 5 wherein said ends of said side cords extend through said at least one slot in said housing and said drum and are interconnected in said internal chamber.

7. The combination of claim 6 wherein there are two slots in each of said housing and said drum and each of said side cords extend through one of said slots in each of said housing and said drum.

8. The combination of claim 2 wherein each of said housing and drum include a mechanical lock component for rotatably securing the housing and the drum together.

9. The combination of claim 8 further including a circumferential detent system for releasably retaining a fixed rotational relationship between said housing and said drum, said detent system including at least one detent in one of said housing and said drum and at least one projection in the other of said housing and drum, said at least one projection being adapted to be releasably seated in said at least one detent to prevent relative rotation between said housing and said drum.

10. The combination of claim 3 wherein said circumferential wall is cylindrical.
